(19) United States
(12) Patent Application Publication
(10) Pub. No.: US 2024/0109781 A1
(43) Pub. Date: Apr. 4, 2024

(54) MANUFACTURING METHOD OF SILICA PARTICLES

(71) Applicant: FUJIFILM Business Innovation Corp., Tokyo (JP)

(72) Inventors: Hajime SUGAHARA, Kanagawa (JP); Sakae TAKEUCHI, Kanagawa (JP); Yuka ZENITANI, Kanagawa (JP); Mai MOCHIDA, Kanagawa (JP); Kota NOHARA, Kanagawa (JP); Mieko SEKI, Kanagawa (JP)

(73) Assignee: FUJIFILM Business Innovation Corp., Tokyo (JP)

(21) Appl. No.: 18/317,091

(22) Filed: May 14, 2023

(30) Foreign Application Priority Data
Sep. 21, 2022 (JP) 2022-150743

(51) Int. Cl. C01B 33/18

(52) U.S. Cl. CPC C01B 33/18

(57) ABSTRACT

A manufacturing method of silica particles includes coating of forming a coating structure composed of a reaction product of a trifunctional silane compound on a surface of silica base particles, attaching a nitrogen element-containing compound containing a molybdenum element to the coating structure in a reaction solution which contains water, an alcohol, silica particles having the coating structure composed of the reaction product of the trifunctional silane compound, the nitrogen element-containing compound containing the molybdenum element, and at least one compound selected from the group consisting of ammonia and an amine and in which a total amount of ammonia and an amine is 0.2% by mass or more and 4.5% by mass or less, and drying of removing the water and the alcohol from the reaction solution.

### CROSS-REFERENCE TO RELATED APPLICATIONS

This application is based on and claims priority under 35 USC 119 from Japanese Patent Application No. 2022-150743 filed Sep. 21, 2022.

### BACKGROUND

### (i) Technical Field

The present disclosure relates to a manufacturing method of silica particles.

### (ii) Related Art

JP2022-018496A discloses resin particles and a manufacturing method thereof, the resin particles having resin base particles and silica particles that are on a surface of the resin base particles, contain a quaternary ammonium salt, and have a surface having undergone a hydrophobic treatment, in which a difference between a detection temperature A and a detection temperature B (detection temperature A−detection temperature B) is higher than 50° C. in a case where the detection temperature A represents a detection temperature derived from a pyrolysate of the quaternary ammonium salt obtained by pyrolysis mass spectrometry on the resin particles before washing and the detection temperature B represents a detection temperature derived from a pyrolysate of the quaternary ammonium salt obtained by pyrolysis mass spectrometry on the resin particles after washing.

JP2022-033224A discloses positively charged hydrophobic spherical silica particles and a manufacturing method thereof, the positively charged hydrophobic spherical silica particles being composed of silica particles that include primary particles having a median diameter (D50) of 5 to 250 nm in a volume-based particle size distribution and have a ratio of D90/D10 of 3 or less an average circularity of 0.8 to 1 and a quaternary salt-type silane compound bonded to a surface of the silica particles.

JP2021-151944A discloses silica particles and a manufacturing method thereof, the silica particles containing a quaternary ammonium salt, in which in a case where F_{BEFORE} represents a maximum frequency of pores having a diameter of 2 nm or less determined from a pore size distribution curve obtained by a nitrogen adsorption method performed on the silica particles before washing and F_{AFTER} represents a maximum frequency of pores having a diameter of 2 nm or less determined from a pore size distribution curve obtained by a nitrogen adsorption method performed on the silica particles after washing, F_{BEFORE}/F_{AFTER} as a ratio of F_{BEFORE} to F_{AFTER} is 0.90 or more and 1.10 or less, and in a case where F_{SINTERING} represents a maximum frequency of pores having a diameter of 2 nm or less determined from a pore size distribution curve obtained by a nitrogen gas adsorption method performed on the silica particles after the silica before washing is baked at 600° C., F_{SINTERING}/F_{BEFORE} as a ratio of F_{SINTERING} to F_{BEFORE} is 5 or more and 20 or less.

### SUMMARY

Aspects of non-limiting embodiments of the present disclosure relate to silica particles that contain a nitrogen element-containing compound containing a molybdenum element and have a narrow charge distribution.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above object include the following aspect.

According to an aspect of the present disclosure, there is provided a manufacturing method of silica particles including coating of forming a coating structure consisting of a reaction product of a trifunctional silane compound on a surface of silica base particles,
attaching a nitrogen element-containing compound containing a molybdenum element to the coating structure in a reaction solution which contains water, an alcohol, silica particles having the coating structure consisting of the reaction product of the trifunctional silane compound, the nitrogen element-containing compound containing the molybdenum element, and at least one compound selected from the group consisting of ammonia and an amine and in which a total amount of ammonia and an amine is 0.2% by mass or more and 4.5% by mass or less, and
drying of removing the water and the alcohol from the reaction solution.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a range of numerical values described using “to” represents a range including the numerical values listed before and after “to” as the minimum value and the maximum value respectively.

Regarding the ranges of numerical values described in stages in the present disclosure, the upper limit or lower limit of a range of numerical values may be replaced with the upper limit or lower limit of another range of numerical values described in stages. Furthermore, in the present disclosure, the upper limit or lower limit of a range of numerical values may be replaced with values described in examples.

In the present disclosure, the term “step” includes not only an independent step but a step which is not clearly distinguished from other steps as long as the goal of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more substances corresponding to each component in the composition, unless otherwise specified, the amount of each component means the total amount of the two or more substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

Manufacturing Method of Silica Particles

The manufacturing method of silica particles according to the present exemplary embodiment includes the following coating step, attaching step, and drying step.

Coating step: a step of forming a coating structure consisting of a reaction product of a trifunctional silane compound on the surface of silica base particles.

Attaching step: a step of attaching a nitrogen element-containing compound containing a molybdenum element to the coating structure in a reaction solution which contains water, an alcohol, silica particles having the coating structure consisting of the reaction product of the trifunctional silane compound, the nitrogen element-containing compound containing the molybdenum element, and at least one compound selected from the group consisting of ammonia and an amine and in which a total amount of ammonia and an amine is 0.2% by mass or more and 4.5% by mass or less.

Drying step: a step of removing the water and the alcohol from the reaction solution.

In the present disclosure, “a nitrogen element-containing compound containing a molybdenum element” will be called “a molybdenum nitrogen-containing compound”.

In the present disclosure, the total amount of ammonia and an amine contained in the reaction solution is called “alkali concentration”. The alkali concentration of the reaction solution is the total mass (% by mass) of ammonia and an amine with respect to the total mass of the reaction solution.

The silica particles manufactured by the manufacturing method according to the present exemplary embodiment have a narrow charge distribution. Presumably, the mechanism is as follows.

In the related art, there are silica particles having a molybdenum nitrogen-containing compound that is a compound acting as a charge control agent having adhered to the surface of the silica particles. Generally, a method of attaching a molybdenum nitrogen-containing compound to the surface of silica particles includes dissolving the molybdenum nitrogen-containing compound in a silica particle suspension and drying the silica particle suspension.

The molybdenum nitrogen-containing compound has low solubility in a medium (usually, a mixed solution of water and alcohol) of the silica particle suspension. Therefore, sometimes the crystals and/or aggregates resulting from the precipitation of the molybdenum nitrogen-containing compound are mixed into the dried silica particles. The silica particles into which the crystals and/or aggregates of the molybdenum nitrogen-containing compound mixed tend to have a wide charge distribution.

To address the above problem, in the manufacturing method according to the present exemplary embodiment, the alkali concentration of the reaction solution is set to 0.2% by mass or more, for the purpose of increasing the solubility of the molybdenum nitrogen-containing compound in the reaction solution in the attaching step. As a result, the solubility of the molybdenum nitrogen-containing compound in the reaction solution is increased, and more molybdenum nitrogen-containing compounds are attached to the coating structure of the silica particles, which inhibits the crystals and/or aggregates of the molybdenum nitrogen-containing compounds from being mixed into the dried silica particles. Therefore, the silica particles manufactured by the manufacturing method according to the present exemplary embodiment have a narrow charge distribution.

In the present exemplary embodiment, the alkali concentration of the reaction solution in the attaching step is 0.2% by mass or more and 4.5% by mass or less.

In a case where the alkali concentration of the reaction solution is less than 0.2% by mass, the molybdenum nitrogen-containing compound has low solubility in the reaction solution, which sometimes causes the crystals and/or aggregates of the molybdenum nitrogen-containing compound to be mixed in the dried silica particles. From the viewpoint of increasing the solubility of the molybdenum nitrogen-containing compound (particularly, the compound with CAS registry number 117342-25-3), the alkali concentration of the reaction solution is 0.2% by mass or more. The alkali concentration of the reaction solution is, for example, preferably 0.5% by mass or more, and more preferably 1.0% by mass or more.

From the viewpoint of increasing the solubility of the molybdenum nitrogen-containing compound in the reaction solution, for example, it is preferable that the alkali concentration be high. However, in a case where the alkali concentration of the reaction solution is too high, the dispersion of silica particles in the reaction solution becomes unstable. From the viewpoint of dispersion stability of the silica particles in the reaction solution, the alkali concentration of the reaction solution is 4.5% by mass or less. The alkali concentration of the reaction solution is, for example, preferably 4.3% by mass or less, and more preferably 4.0% by mass or less.

In the present disclosure, the silica particles manufactured by the manufacturing method according to the present exemplary embodiment are called “silica particles (S)”.

In a molybdenum element map created by SEM-EDX for the silica particles (S), for example, a ratio of a total area of a region forming a lump having a long diameter of 500 nm or more is preferably 5% or less to a total area of the molybdenum element.

In the present disclosure, “a region forming a lump having a long diameter of 500 nm or more in a molybdenum element map created by SEM-EDX” is called “a molybdenum lump”, and “a ratio of a total area of a region forming a lump having a long diameter of 500 nm or more to a total area of the molybdenum element in the molybdenum element map created by SEM-EDX” is called “an abundance ratio of the molybdenum lump”.

The abundance ratio of the molybdenum lump is a characteristic measured by scanning electron microscope-energy dispersive X-ray spectroscopy (SEM-EDX).

Specifically, the abundance ratio is measured by the following method.

Silica particles are spread on a carbon tape and fixed. At this time, the silica particles are dispersed such that the silica particles do not come into contact with each other or overlap with each other as much as possible, and the density of the silica particles is adjusted such that 500 or more and 2,000 or less silica particles are observed in one field of view of SEM at 180× magnification.

Carbon is vacuum-deposited on the silica particles, thereby preparing an SEM sample. The carbon deposition is performed for 70 seconds.

By using SEM (manufactured by Hitachi High-Tech Corporation., S-4800) equipped with an EDX device (manufactured by HORIBA, Ltd., EMAX ENERGY, detector: X-Max 80 mm²), the sample is imaged at 180× magnification. The acceleration voltage of SEM is 10 kV, and EDX detection is performed for 300 seconds for the molybdenum element. Three fields of view are images, and a total of 1,500 or more and 6,000 or less silica particles are observed. EDX mapping data of the molybdenum element is analyzed by image processing/analyzing software WinRoof (MITANI CORPORATION) and binarized by setting 10% of the maximum brightness (L) and chroma (S) in color extraction to be a threshold, thereby creating a binarized molybdenum element map.

In the binarized molybdenum element map, a total area A1 of the molybdenum element and a total area A2 of a region forming a lump having a long diameter (that is, the major axis length of the contour) of 500 nm or more are calculated. The area ratio (percentage) of A2 to A1 is defined as “an abundance ratio of a molybdenum lump”.

Based on the presence of the molybdenum element and the shape and size observed in the SEM image, the molybdenum lumps in the molybdenum element map of the silica particles are assumed to be crystals and/or aggregates of the molybdenum nitrogen-containing compound. The presence of the molybdenum lumps in the molybdenum element map of the silica particles means that the crystals and/or aggregates of the molybdenum nitrogen-containing compound are mixed in the silica particles.

For example, the lower the abundance ratio of the molybdenum lump in the silica particles (S), the more preferable. Specifically, the abundance ratio of the molybdenum lump is, for example, preferably 5% or less, more preferably 3% or less, even more preferably 1% or less, and ideally 0%.

Hereinafter, each step of the manufacturing method of silica particles and the configuration and components of the silica particles will be specifically described.

Silica Base Particles

The silica base particles may be dry silica or wet silica.

Examples of the dry silica include silica by a combustion method (fumed silica) obtained by combustion of a silane compound and silica by a deflagration method obtained by explosive combustion of metallic silicon powder.

Examples of the wet silica include wet silica obtained by a neutralization reaction between sodium silicate and a mineral acid (silica by a precipitation method synthesized/aggregated under alkaline conditions, silica by a gelation method synthesized/aggregated under acidic conditions), colloidal silica obtained by alkalifying and polymerizing acidic silicate, and sol-gel silica obtained by the hydrolysis of an organic silane compound (for example, alkoxysilane).

As the silica base particles, from the viewpoint of charge distribution narrowing, for example, sol-gel silica is preferable.

For example, it is preferable that the silica base particles to be used in the coating step be prepared as a silica base particle suspension by the following step (i) or step (ii).

Step (i): a step of mixing an alcohol-containing solvent with silica base particles to prepare a silica base particle suspension.

Step (ii): a step of granulating silica base particles by a sol-gel method to obtain a silica base particle suspension.

The silica base particles used in the step (i) may be dry silica or wet silica. Specific examples thereof include sol-gel silica, aqueous colloidal silica, alcoholic silica, fumed silica, molten silica, and the like.

The alcohol-containing solvent used in the step (i) may be a solvent composed only of an alcohol or a mixed solvent of an alcohol and other solvents. In the case of the mixed solvent, the proportion of the alcohol is, for example, preferably 80% by mass or more, and more preferably 85% by mass or more.

Examples of the alcohol configuring the alcohol-containing solvent include lower alcohols such as methanol, ethanol, 1-propanol, isopropanol, 1-butanol (n-butyl alcohol), 2-methyl-1-propanol (isobutyl alcohol), 2-butanol (sec-butyl alcohol), and 2-methyl-2-propanol (tert-butyl alcohol). Among these, from the viewpoint of low reactivity with tetraalkoxysilane and silica, dispersion stability of silica particles, high removability in a drying step, and the like, for example, at least one alcohol selected from the group consisting of methanol, ethanol, 1-propanol, 2-propanol, and 2-methyl-2-propanol is preferable.

Examples of solvents other than the alcohol configuring the alcohol-containing solvent include water; ketones such as acetone, methyl ethyl ketone, and methyl isobutyl ketone; cellosolves such as methyl cellosolve, ethyl cellosolve, butyl cellosolve, and cellosolve acetate; ethers such as dioxane and tetrahydrofuran; and the like.

As the solvent alcohol-containing solvent, for example, a mixed solvent of a lower alcohol and water is preferable, and a mixed solvent of water and at least one alcohol selected from the group consisting of methanol, ethanol, 1-propanol, 2-propanol, and 2-methyl-2-propanol is more preferable. The proportion of the alcohol in such a mixed solvent is, for example, preferably 80% by mass or more, and more preferably 85% by mass or more.

In the present disclosure, the step (ii) is also called “granulating step”. The granulating step will be specifically described below.

Granulating Step

The granulating step is a step of granulating silica base particles by a sol-gel method. By the granulating step, a silica base particle suspension to be used in the coating step is obtained.

The granulating step is, for example, preferably a sol-gel method including an alkali catalyst solution preparation step of preparing an alkali catalyst solution composed of an alcohol-containing solvent containing an alkali catalyst and a silica base particle generation step of supplying tetraalkoxysilane and an alkali catalyst to the alkali catalyst solution to generate silica base particles.

The alkali catalyst solution preparation step is, for example, preferably a step of preparing an alcohol-containing solvent and mixing the solvent with an alkali catalyst to obtain an alkali catalyst solution.

The alcohol-containing solvent may be a solvent composed only of an alcohol or a mixed solvent of an alcohol and other solvents. In the case of the mixed solvent, the proportion of the alcohol is, for example, preferably 80% by mass or more, and more preferably 85% by mass or more.

Examples of the alcohol configuring the alcohol-containing solvent include lower alcohols such as methanol, ethanol, 1-propanol, isopropanol, 1-butanol (n-butyl alcohol), 2-methyl-1-propanol (isobutyl alcohol), 2-butanol (sec-butyl alcohol), and 2-methyl-2-propanol (tert-butyl alcohol). Among these, from the viewpoint of low reactivity with tetraalkoxysilane and silica, dispersion stability of silica particles, high removability in a drying step, and the like, for example, at least one alcohol selected from the group consisting of methanol, ethanol, 1-propanol, 2-propanol, and 2-methyl-2-propanol is preferable.

Examples of solvents other than the alcohol configuring the alcohol-containing solvent include water; ketones such as acetone, methyl ethyl ketone, and methyl isobutyl ketone; cellosolves such as methyl cellosolve, ethyl cellosolve, butyl cellosolve, and cellosolve acetate; ethers such as dioxane and tetrahydrofuran; and the like.

The alkali catalyst is a catalyst for accelerating the reaction of tetraalkoxysilane (a hydrolysis reaction and a condensation reaction). Examples thereof include basic catalysts such as ammonia, urea, and monoamine. Among these, for example, ammonia is particularly preferable.

An example of the alkali catalyst solution preparation step includes mixing an alcohol with aqueous ammonia. According to the present embodiment, an alkali catalyst solution composed of a mixed solvent of an alcohol and water and ammonia dissolved in the mixed solvent is obtained. As the alcohol, for example, a lower alcohol is preferable, and at least one alcohol selected from the group consisting of methanol, ethanol, 1-propanol, 2-propanol, and 2-methyl-2-propanol is more preferable. The proportion of the alcohol in the mixed solvent of the alcohol and water is, for example, preferably 80% by mass or more, and more preferably 85% by mass or more.

The concentration of the alkali catalyst in the alkali catalyst solution is, for example, preferably 0.5 mol/L or more and 1.5 mol/L or less, more preferably 0.6 mol/L or more and 1.2 mol/L or less, and even more preferably 0.65 mol/L or more and 1.1 mol/L or less.

The silica base particle generation step is a step of supplying tetraalkoxysilane and an alkali catalyst to the alkali catalyst solution and reacting the tetraalkoxysilane (a hydrolysis reaction and condensation reaction) in the alkali catalyst solution to generate silica base particles.

In the silica base particle generation step, core particles are generated by the reaction of the tetraalkoxysilane at the early stage of supplying tetraalkoxysilane (core particle generation stage), and then silica base particles are generated through the growth of the core particles (core particle growth stage).

Examples of the tetraalkoxysilane include tetramethoxysilane, tetraethoxysilane, tetrapropoxysilane, tetrabutoxysilane, and the like. From the viewpoint of controlling the reaction rate or uniformity of the shape of the silica base particles to be generated, for example, tetramethoxysilane or tetraethoxysilane is preferable.

The alkali catalyst supplied into the alkali catalyst solution may be a compound of the same type as or different type from the alkali catalyst contained in the alkali catalyst solution in advance. For example, it is preferable that the alkali catalysts be of the same type of compounds.

Examples of the alkali catalyst supplied to the alkali catalyst solution include basic catalysts such as ammonia, urea, and monoamine. Among these, for example, ammonia is particularly preferable. For example, aqueous ammonia is preferably added dropwise such that ammonia is supplied into the alkali catalyst solution.

The method for supplying the tetraalkoxysilane and the alkali catalyst to the alkali catalyst solution may be a continuous supply method or an intermittent supply method.

In the silica base particle generation step, the temperature of the alkali catalyst solution (temperature at the time of supply) is, for example, preferably 5° C. or higher and 50° C. or lower, and more preferably 15° C. or higher and 45° C. or lower.

Coating Step

The coating step is a step of forming a coating structure consisting of a reaction product of a trifunctional silane compound on at least a part of the surface of the silica base particles (for example, preferably on the entire surface of the silica base particles).

In a case where a non-functional group of the trifunctional silane compound used in the coating step is a hydrophobic group such as an alkyl group, the coating structure is formed by the coating step, and the surface of the silica particles is made hydrophobic.

In the coating step, for example, a trifunctional silane compound is added to the silica base particle suspension such that the trifunctional silane compound has a reaction within the surface of the silica base particles, and in this way, a coating structure consisting of the reaction product of the trifunctional silane compound is formed.

For example, the reaction of the trifunctional silane compound is performed by adding a trifunctional silane compound to the silica base particle suspension, and then heating the suspension with stirring. Specifically, for example, the suspension is heated to a temperature of 40° C. or higher and 70° C. or lower, a trifunctional silane compound is added to the suspension with stirring, and stirring is continued. The stirring is continued, for example, preferably for 10 minutes or more and 24 hours or less, more preferably for 60 minutes or more and 420 minutes or less, and even more preferably 80 minutes or more and 300 minutes or less.

Trifunctional Silane Compound and Coating Structure

The coating structure consisting of the reaction product of the trifunctional silane compound has lower density compared to the silica base particles and has a pore structure. In addition, the coating structure consisting of the reaction product of the trifunctional silane compound has high affinity with the molybdenum nitrogen-containing compound. Presumably, accordingly, the molybdenum nitrogen-containing compound may enter into the coating structure (that is, into the pores of the pore structure), which may make the silica particles (S) have a relatively high content of the molybdenum nitrogen-containing compound.

The molybdenum nitrogen-containing compound that tends to be positively charged adheres to the surface of the silica base particles that tends to be negatively charged, which brings about an effect of canceling out an excess of negative charge of the silica base particles. The molybdenum nitrogen-containing compound has adhered to the inside of the coating structure (for example, preferably to the inside of pores of the pore structure) within the surface of the silica particles (S). Accordingly, the charge distribution of the silica particles (S) does not widen toward the positive charge side, and an excess of negative charge of the silica base particles is canceled out, which makes it possible to narrow the charge distribution of the silica particles (S).

The trifunctional silane compound is, for example, preferably a compound that does not contain N (nitrogen element). As the trifunctional silane compound, for example, a compound represented by Formula (S) is preferable.

RSiX₃ Formula (S)

In Formula (S), R represents a hydrocarbon group having 1 or more and 6 or less carbon atoms, and three X's each independently represent a hydroxyl group or a hydrolyzable group.

Examples of the reaction product of the trifunctional silane compound include a reaction product represented by Formula (S) in which some or all of X's are substituted with a OH group; a reaction product represented by Formula (S) in which some or all of the groups formed by the substitution of X with a OH group are polycondensed; and a reaction product represented by Formula (S) in which some or all of the groups formed by the substitution of X are polycondensed with a OH group and a SiOH group of the silica base particles.

Examples of the hydrocarbon group having 1 or more and 6 or less carbon atoms represented by R in Formula (S) include an aliphatic hydrocarbon group and a phenyl group. The hydrogen atom of the aliphatic hydrocarbon group may be substituted with a halogen atom. The hydrogen atom of the phenyl group may be substituted with a halogen atom.

In a case where R represents an aliphatic hydrocarbon group, the aliphatic hydrocarbon group may be linear, branched, or cyclic. The aliphatic hydrocarbon group is, for example, preferably linear or branched. The aliphatic hydrocarbon group may be saturated or unsaturated. The aliphatic hydrocarbon group is, for example, preferably a saturated aliphatic hydrocarbon group, that is, an alkyl group.

Examples of the linear alkyl group having 1 or more and 6 or less carbon atoms include a methyl group, an ethyl group, a n-propyl group, a n-butyl group, a n-pentyl group, and a n-hexyl group.

Examples of the branched alkyl group having 3 or more and 6 or less carbon atoms include an isopropyl group, an isobutyl group, a sec-butyl group, a tert-butyl group, an isopentyl group, a neopentyl group, a tert-pentyl group, an isohexyl group, a sec-hexyl group, and a tert-hexyl group.

Examples of the cyclic alkyl group having 3 or more and 6 or less carbon atoms include a cyclopropyl group, a cyclobutyl group, a cyclopentyl group, a cyclohexyl group, and a polycyclic alkyl group composed of these monocyclic alkyl groups linked to each other.

R in Formula (S) is, for example, preferably a linear alkyl group having 1 or more and 6 or less carbon atoms or a branched alkyl group having 3 or more and 6 or less carbon atoms, more preferably a linear alkyl group having 1 or more and 4 or less carbon atoms, and even more preferably a methyl group or an ethyl group.

Examples of the hydrolyzable group represented by X in Formula (S) include an alkoxy group. Examples of the alkoxy group include a linear, branched, or cyclic alkoxy group having 1 or more and 6 or less carbon atoms. The hydrogen atom of the alkoxy group may be substituted with a halogen atom.

Examples of the linear alkoxy group having 1 or more and 6 or less carbon atoms include a methoxy group, an ethoxy group, a n-propoxy group, a n-butoxy group, a n-pentyloxy group, and a n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Three X's in Formula (S), for example, preferably each independently represent a linear alkoxy group having 1 or more and 6 or less carbon atoms or a branched alkoxy group having 3 or more and 6 or less carbon atoms, more preferably each independently represent a linear alkoxy group having 1 or more and 4 or less carbon atoms, and even more preferably each independently represent a methoxy group or an ethoxy group.

Examples of the trifunctional silane compound include methyltrimethoxysilane, ethyltrimethoxysilane, propyltrimethoxysilane, butyltrimethoxysilane, hexyltrimethoxysilane, methyltriethoxysilane, ethyltriethoxysilane, butyltriethoxysilane, hexyltriethoxysilane, phenyltrimethoxysilane, phenyltriethoxysilane, and the like. One trifunctional silane compound may be used alone, or two or more trifunctional silane compounds may be used in combination.

As the trifunctional silane compound, for example, alkyltrialkoxysilane is preferable; at least one trifunctional silane compound selected from the group consisting of alkyltrimethoxysilane and alkyltriethoxysilane having an alkyl group having 1 or more and 6 or less carbon atoms is more preferable;
at least one trifunctional silane compound selected from the group consisting of alkyltrimethoxysilane and alkyltriethoxysilane having an alkyl group having 1 or more and 4 or less carbon atoms is more preferable; and
at least one trifunctional silane compound selected from the group consisting of methyltrimethoxysilane, ethyltrimethoxysilane, methyltriethoxysilane, and ethyltriethoxysilane is particularly preferable.

The mass ratio of the coating structure configured with the reaction product of the trifunctional silane compound to the total amount of the silica particles (S) is, for example, preferably 5.5% by mass or more and 30% by mass or less, and more preferably 7% by mass or more and 22% by mass or less.

Attaching Step

The attaching step is a step of attaching a molybdenum nitrogen-containing compound to the coating structure of the silica particles having the coating structure consisting of the reaction product of the trifunctional silane compound. The attaching step is, for example, preferably a step of attaching a molybdenum nitrogen-containing compound to the inside of pores of the pore structure consisting of the reaction product of the trifunctional silane compound.

The reaction solution in the attaching step contains water, an alcohol, silica particles having a coating structure consisting of a reaction product of a trifunctional silane compound, a molybdenum nitrogen-containing compound, and at least one compound selected from the group consisting of ammonia and an amine, in which the total amount of ammonia and an amine (called “alkali concentration” in the present disclosure) is 0.2% by mass or more and 4.5% by mass or less.

From the viewpoint of increasing the solubility of the molybdenum nitrogen-containing compound (particularly, the compound with CAS registry number 117342-25-3), the alkali concentration of the reaction solution is 0.2% by mass or more. The alkali concentration of the reaction solution is, for example, preferably 0.5% by mass or more, and more preferably 1.0% by mass or more.

From the viewpoint of dispersion stability of the silica particles in the reaction solution, the alkali concentration of the reaction solution is 4.5% by mass or less. The alkali concentration of the reaction solution is, for example, preferably 4.3% by mass or less, and more preferably 4.0% by mass or less.

From the viewpoint of increasing the solubility of the molybdenum nitrogen-containing compound (particularly, the compound with CAS registry number 117342-25-3), at least one compound selected from the group consisting of ammonia and an amine contained in the reaction solution is, for example, preferably at least one compound selected from the group consisting of ammonia, dimethylamine, and diethylamine. That is, the reaction solution preferably contains, for example, at least one compound selected from the group consisting of ammonia, dimethylamine, and diethylamine.

From the viewpoint of increasing the solubility of the molybdenum nitrogen-containing compound, the total amount of ammonia, dimethylamine, and diethylamine contained in the reaction solution is, for example, preferably 0.2% by mass or more, more preferably 0.5% by mass or more, and even more preferably 1.0% by mass or more.

From the viewpoint of dispersion stability of the silica particles in the reaction solution, the total amount of ammonia, dimethylamine, and diethylamine contained in the reaction solution is, for example, preferably 4.5% by mass or less, more preferably 4.3% by mass or less, and even more preferably 4.0% by mass or less.

From the viewpoint of increasing the solubility of the molybdenum nitrogen-containing compound (particularly, the compound with CAS registry number 117342-25-3), at least one compound selected from the group consisting of ammonia and an amine contained in the reaction solution is, for example, particularly preferably ammonia. That is, it is particularly preferable that the reaction solution contain, for example, ammonia.

From the viewpoint of increasing the solubility of the molybdenum nitrogen-containing compound, the total amount of ammonia contained in the reaction solution is, for example, preferably 0.2% by mass or more, more preferably 0.5% by mass or more, and even more preferably 1.0% by mass or more.

From the viewpoint of dispersion stability of the silica particles in the reaction solution, the amount of ammonia contained in the reaction solution is, for example, preferably 4.5% by mass or less, more preferably 4.3% by mass or less, and even more preferably 4.0% by mass or less.

The amount of the molybdenum nitrogen-containing compound contained in the reaction solution with respect to 100 parts by mass of the silica particles having the coating structure consisting of the reaction product of the trifunctional silane compound is, for example, preferably 1 part by mass or more and 5 parts by mass or less, more preferably 1.2 parts by mass or more and 4.8 parts by mass or less, and even more preferably 1.5 parts by mass or more and 4.5 parts by mass or less.

Examples of the alcohol configuring the reaction solution include lower alcohols such as methanol, ethanol, 1-propanol, isopropanol, 1-butanol (n-butyl alcohol), 2-methyl-1-propanol (isobutyl alcohol), 2-butanol (sec-butyl alcohol), and 2-methyl-2-propanol (tert-butyl alcohol). Among these, from the viewpoint of low reactivity with tetraalkoxysilane and silica, dispersion stability of silica particles, high removability in a drying step, and the like, for example, at least one alcohol selected from the group consisting of methanol, ethanol, 1-propanol, 2-propanol, and 2-methyl-2-propanol is preferable.

From the viewpoint of dispersion stability of the silica particles, the amount of the alcohol contained in the reaction solution with respect to the total amount of the reaction solution is, for example, preferably 45% by mass or more and 95% by mass or less, more preferably 46% by mass or more and 94% by mass or less, and even more preferably 48% by mass or more and 92% by mass or less.

It is preferable that the attaching step include, for example, a reaction solution preparation step of preparing a reaction solution and a stirring step of stirring the reaction solution while keeping the temperature of the reaction solution in a desired range.

The reaction solution preparation step is performed, for example, by adding a molybdenum nitrogen-containing compound to the silica particle suspension (hereinafter, simply called “suspension” in the description of the reaction solution preparation step) obtained after the reaction between the silica base particles and a trifunctional silane compound. The reaction solution contains water brought in from the suspension, an alcohol, silica particles having a coating structure consisting of a reaction product of a trifunctional silane compound, and an alkali catalyst.

The reaction solution preparation step may include adding at least one compound selected from the group consisting of ammonia and an amine to the suspension, for the purpose of adjusting the alkali concentration of the reaction solution to 0.2% by mass or more and 4.5% by mass or less.

The reaction solution preparation step may include adding an alcohol and/or water to the suspension, for the purpose of adjusting the alkali concentration of the reaction solution to 0.2% by mass or more and 4.5% by mass or less.

There are no restrictions on the method and order of mixing together components in the reaction solution preparation step.

In an example of the exemplary embodiment, a molybdenum nitrogen-containing compound is added to the suspension, and at least one compound selected from the group consisting of ammonia and an amine is then further added to the suspension, such that the alkali concentration of the reaction solution is adjusted to 0.2% by mass or more and 4.5% by mass or less.

In another example of the exemplary embodiment, at least one compound selected from the group consisting of ammonia and an amine is added to the suspension, and then a molybdenum nitrogen-containing compound is added to the suspension to obtain a reaction solution having an alkali concentration of 0.2% by mass or more and 4.5% by mass or less.

In the reaction solution preparation step, a molybdenum nitrogen-containing compound is added to the suspension, for example, by the following (1) and/or (2).
(1) A molybdenum nitrogen-containing compound is directly added to the suspension.
(2) An alcohol solution containing a molybdenum nitrogen-containing compound is prepared in advance, and the alcohol solution is added to the suspension. The alcohol of the alcohol solution may be of the same type as or different type from the alcohol contained in the suspension. For example, it is preferable that the alcohol in the alcohol solution be of the same type as the alcohol in the suspension. In the alcohol solution, the concentration of the molybdenum nitrogen-containing compound is, for example, preferably 0.05% by mass or more and 10% by mass or less, and more preferably 0.1% by mass or more and 6% by mass or less.

The stirring step is preferably a step of stirring the reaction solution for 1 hour or more while keeping the temperature of the reaction solution in a range of 25° C. or higher and 65° C. or lower. The temperature of the reaction solution is, for example, more preferably in a range of 30° C. or higher and 65° C. or lower, and even more preferably in a range of 35° C. or higher and 65° C. or lower. The stirring is continued, for example, preferably for 1 hour or more and 24 hours or less, more preferably for 1.5 hours or more and 12 hours or less, and even more preferably 2 hours or more and 6 hours or less. While stirring is being continued, the temperature of the reaction solution may be constant or change in the above temperature range.

Molybdenum Nitrogen-Containing Compound

The molybdenum nitrogen-containing compound is a nitrogen element-containing compound containing a molybdenum element, excluding ammonia and a compound that is in a gaseous state at a temperature of 25° C. or lower.

The molybdenum nitrogen-containing compound preferably has adhered, for example, to the inside of the coating structure (that is, to the inside of the pore structure) consisting of the reaction product of the trifunctional silane compound. One molybdenum nitrogen-containing compound or two or more molybdenum nitrogen-containing compounds may be used.

From the viewpoint of charge distribution narrowing and charge distribution retentivity, the molybdenum nitrogen-containing compound is, for example, preferably at least one compound selected from the group consisting of a quaternary ammonium salt containing a molybdenum element (particularly, a quaternary ammonium salt of molybdic acid) and a mixture of a quaternary ammonium salt and a metal oxide containing a molybdenum element. In the quaternary ammonium salt containing a molybdenum element, the bond between an anion containing a molybdenum element and a quaternary ammonium cation is strong. Therefore, the quaternary ammonium salt containing a molybdenum element has high charge distribution retentivity.

As the molybdenum nitrogen-containing compound, for example, a compound represented by Formula (1) is preferable.

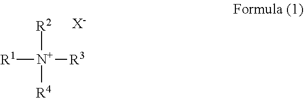

In Formula (1), R¹, R², R³, and R⁴ each independently represent a hydrogen atom, an alkyl group, an aralkyl group, or an aryl group, and X⁻ represents an anion containing a molybdenum element. Here, at least one of R¹, R², R³, or R⁴ represents an alkyl group, an aralkyl group, or an aryl group. Furthermore, two or more out of R¹, R², R³, and R⁴ may be linked to form an aliphatic ring, an aromatic ring, or a heterocycle. The alkyl group, the aralkyl group, and the aryl group may have a substituent.

Examples of the alkyl group represented by R¹ to R⁴ include a linear alkyl group having 1 or more and 20 or less carbon atoms and a branched alkyl group having 3 or more and 20 or less carbon atoms. Examples of the linear alkyl group having 1 or more and 20 or less carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, and the like. Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, and the like.

As the alkyl group represented by R¹ to R⁴, for example, an alkyl group having 1 or more and 15 or less carbon atoms, such as a methyl group, an ethyl group, a butyl group, or a tetradecyl group, is preferable.

Examples of the aralkyl group represented by R¹ to R⁴ include an aralkyl group having 7 or more and 30 or less carbon atoms. Examples of the aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, a phenyl-cyclopentylmethyl group, and the like.

As the aralkyl group represented by R¹ to R⁴, for example, an aralkyl group having 7 or more and 15 or less carbon atoms, such as a benzyl group, a phenylethyl group, a phenylpropyl group, or a 4-phenylbutyl group, is preferable.

Examples of the aryl group represented by R¹ to R⁴ include an aryl group having 6 or more and 20 or less carbon atoms. Examples of the aryl group having 6 to 20 carbon atoms include a phenyl group, a pyridyl group, a naphthyl group, and the like.

As the aryl group represented by R¹ to R⁴, for example, an aryl group having 6 or more and 10 or less carbon atoms, such as a phenyl group, is preferable.

Examples of the ring formed of two or more of R¹, R², R³, and R⁴ linked to each other include an alicyclic ring having 2 or more and 20 or less carbon atoms, a heterocyclic amine having 2 or more and 20 or less carbon atoms, and the like.

R¹, R², R³, and R⁴ may each independently have a substituent. Examples of the substituent include a nitrile group, a carbonyl group, an ether group, an amide group, a siloxane group, a silyl group, an alkoxysilane group, and the like.

It is preferable that R¹, R², R³, and R⁴ each independently represent, for example, an alkyl group having 1 or more and 16 or less carbon atoms, an aralkyl group having 7 or more and 10 or less carbon atoms, or an aryl group having 6 or more and 20 or less carbon atoms.

The anion containing a molybdenum element represented by X⁻ is, for example, preferably a molybdate ion, more preferably a molybdate ion having tetravalent or hexavalent molybdenum, and more preferably a molybdate ion having hexavalent molybdenum. Specifically, as the molybdate ion, for example, MoO₄²⁻, Mo₂O₇²⁻, Mo₃O₁₀²⁻, Mo₄O₁₃²⁻, Mo₇O₂₄²⁻, and Mo₈O₂₆⁴⁻ are preferable.

From the viewpoint of charge distribution narrowing and charge distribution retentivity, the total number of carbon atoms in the compound represented by Formula (1) is, for example, preferably 18 or more and 35 or less, and more preferably 20 or more and 32 or less.

Examples of the compound represented by Formula (1) will be shown below. The present exemplary embodiment is not limited thereto.

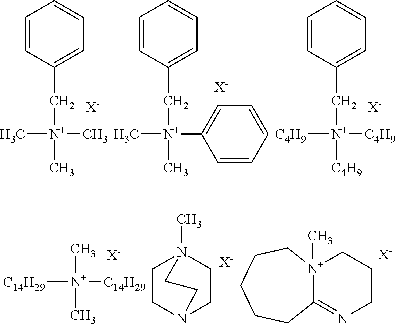

Examples of the quaternary ammonium salt containing a molybdenum element include a quaternary ammonium salt of molybdic acid such as [N⁺(CH)₃(C₁₄C₂₉)₂]₄MosO₂₈⁴⁻, [N⁺(C₄H₉)₂(C₆H₆)₂]₂Mo₂O₇²⁻, [N⁺(CH₃)₂(CH₂C₆H₆)(CH₂)₁₇CH₃]₂MoO₄²⁻, and [N⁺(CH₃)₂(CH₂C₆H₆)(CH₂)₁₅CH₃]₂MoO₄²⁻.

Examples of the metal oxide containing a molybdenum element include a molybdenum oxide (molybdenum trioxide, molybdenum dioxide, or Mo₉O₂₆), a molybdic acid alkali metal salt (such as lithium molybdate, sodium molybdate, or potassium molybdate), a molybdenum alkaline earth metal salt (such as magnesium molybdate or calcium molybdate) and other composite oxides (such as Bi₂O₃·2MoO₃ or γ-Ce₂Mo₃O₁₃).

As the molybdenum nitrogen-containing compound, for example, the compound with CAS registry number 117342-25-3 is particularly preferable. The compound with CAS registry number 117342-25-3 has TP-415, 1-Tetradecanaminium, N,N-dimethyl-N-tetradecyl-, hexa-.mu.-oxotetra-.mu.3-oxodi-.mu.5-oxotetradecaoxooctamolybdate(4-)(4:1) as other names.

In a case where the specific silica particles (S) are heated at a temperature in a range of 300° C. or higher and 600° C. or lower, a molybdenum nitrogen-containing compound is detected. The molybdenum nitrogen-containing compound can be detected by heating at a temperature of 300° C. or higher and 600° C. or lower in an inert gas. For example, the molybdenum nitrogen-containing compound is detected using a heating furnace-type drop-type pyrolysis gas chromatography mass spectrometer using He as a carrier gas. Specifically, by introducing silica particles in an amount of 0.1 mg or more and 10 mg or less into a pyrolysis gas chromatograph mass spectrometer, it is possible to check whether or not the silica particles contain a molybdenum nitrogen-containing compound from the MS spectrum of the detected peak. Examples of components generated by pyrolysis from the silica particles containing a molybdenum nitrogen-containing compound include a primary, secondary, or tertiary amine represented by Formula (2) and an aromatic nitrogen compound. R¹, R², and R³ in Formula (2) have the same definition as R¹, R², and R³ in Formula (1) respectively. In a case where the molybdenum nitrogen-containing compound is a quaternary ammonium salt, some of the side chains thereof are detached by pyrolysis at 600° C., and a tertiary amine is detected.

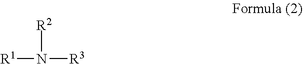

Nitrogen Element-Containing Compound that does not Contain Molybdenum Element

In the silica particles (S), a nitrogen element-containing compound that does not contain a molybdenum element may adhere to the coating structure (for example, preferably the pore structure) of the reaction product of the trifunctional silane compound.

The nitrogen element-containing compound that does not contain a molybdenum element may be introduced into the silica particles (S), for example, for the purpose of controlling the charging properties or the degree of hydrophobicity of the silica particles (S). Additionally incorporating the nitrogen element-containing compound that does not contain a molybdenum element into the reaction solution in the attaching step enables the nitrogen element-containing compound that does not contain a molybdenum element to adhere to the inside of the coating structure (for example, preferably to the inside of pores of the pore structure) of the reaction product of the trifunctional silane compound.

Examples of the nitrogen element-containing compound that does not contain a molybdenum element include at least one compound selected from the group consisting of a quaternary ammonium salt, a primary amine compound, a secondary amine compound, a tertiary amine compound, an amide compound, an imine compound, and a nitrile compound. The nitrogen element-containing compound that does not contain a molybdenum element is, for example, preferably a quaternary ammonium salt.

Specific examples of the primary amine compound include phenethylamine, toluidine, catecholamine, and 2,4,6-trimethylaniline.

Specific examples of the secondary amine compound include dibenzylamine, 2-nitrodiphenylamine, and 4-(2-octylamino)diphenylamine.

Specific examples of the tertiary amine compound include 1,8-bis(dimethylamino)naphthalene, N,N-dibenzyl-2-aminoethanol, and N-benzyl-N-methylethanolamine.

Specific examples of the amide compound include N-cyclohexyl-p-toluenesulfonamide, 4-acetamide-1-benzylpiperidine, and N-hydroxy-3-[1-(phenylthio)methyl-1H-1,2,3-triazol-4-yl]benzamide.

Specific examples of the imine compound include diphenylmethaneimine, 2,3-bis(2,6-diisopropylphenylimino)butane, and N,N′-(ethane-1,2-diylidene)bis(2,4,6-trimethylaniline). Specific examples of the nitrile compound include 3-indoleacetonitrile, 4-[(4-chloro-2-pyrimidinyl)amino]benzonitrile, and 4-bromo-2,2-diphenylbutyronitrile.

Examples of the quaternary ammonium salt include a compound represented by Formula (AM). One compound represented by Formula (AM) or two or more compounds represented by Formula (AM) may be used.

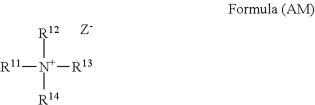

In Formula (AM), R¹¹, R¹², R¹³, and R¹⁴ each independently represent a hydrogen atom, an alkyl group, an aralkyl group, or an aryl group, and Z⁻ represents an anion. Here, at least one of R¹¹, R¹², R¹³, or R¹⁴ represents an alkyl group, an aralkyl group, or an aryl group. Furthermore, two or more out of R¹¹, R¹², R¹³, and R¹⁴ may be linked to form an aliphatic ring, an aromatic ring, or a heterocycle. The alkyl group, the aralkyl group, and the aryl group may have a substituent.

Examples of the alkyl group represented by R¹¹ to R¹⁴ include a linear alkyl group having 1 or more and 20 or less carbon atoms and a branched alkyl group having 3 or more and 20 or less carbon atoms. Examples of the linear alkyl group having 1 or more and 20 or less carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, and the like. Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, and the like.

As the alkyl group represented by R¹¹ to R¹⁴, for example, an alkyl group having 1 or more and 15 or less carbon atoms, such as a methyl group, an ethyl group, a butyl group, or a tetradecyl group, is preferable.

Examples of the aralkyl group represented by R¹¹ to R¹⁴ include an aralkyl group having 7 or more and 30 or less carbon atoms. Examples of the aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, a phenyl-cyclopentylmethyl group, and the like.

As the aralkyl group represented by R¹¹ to R¹⁴, for example, an aralkyl group having 7 or more and 15 or less carbon atoms, such as a benzyl group, a phenylethyl group, a phenylpropyl group, or a 4-phenylbutyl group, is preferable.

Examples of the aryl group represented by R¹¹ to R¹⁴ include an aryl group having 6 or more and 20 or less carbon atoms. Examples of the aryl group having 6 to 20 carbon atoms include a phenyl group, a pyridyl group, a naphthyl group, and the like.

As the aryl group represented by R¹¹ to R¹⁴, for example, an aryl group having 6 or more and 10 or less carbon atoms, such as a phenyl group, is preferable.

Examples of the ring formed of two or more of R¹¹, R¹², R¹³, and R¹⁴ linked to each other include an alicyclic ring having 2 or more and 20 or less carbon atoms, a heterocyclic amine having 2 or more and 20 or less carbon atoms, and the like.

R¹¹, R¹², R¹³, and R¹⁴ may each independently have a substituent. Examples of the substituent include a nitrile group, a carbonyl group, an ether group, an amide group, a siloxane group, a silyl group, an alkoxysilane group, and the like.

It is preferable that R¹¹, R¹², R¹³, and R¹⁴ each independently represent, for example, an alkyl group having 1 or more and 16 or less carbon atoms, an aralkyl group having 7 or more and 10 or less carbon atoms, or an aryl group having 6 or more and 20 or less carbon atoms.

The anion represented by Z⁻ may be any of an organic anion and an inorganic anion.

Examples of the organic anion include a polyfluoroalkylsulfonate ion, a polyfluoroalkylcarboxylate ion, a tetraphenylborate ion, an aromatic carboxylate ion, an aromatic sulfonate ion (such as a 1-naphthol-4-sulfonate ion), and the like.

Examples of the inorganic anion include OH⁻, F⁻, Fe(CN)₆³⁻, Cl⁻, Br⁻, NO₂⁻, NO₃⁻, CO₃²⁻, PO₄³⁻, SO₄²⁻, and the like.

From the viewpoint of charge distribution narrowing and charge distribution retentivity, the total number of carbon atoms in the compound represented by Formula (AM) is, for example, preferably 18 or more and 35 or less, and more preferably 20 or more and 32 or less.

Examples of the compound represented by Formula (AM) will be shown below. The present exemplary embodiment is not limited thereto.

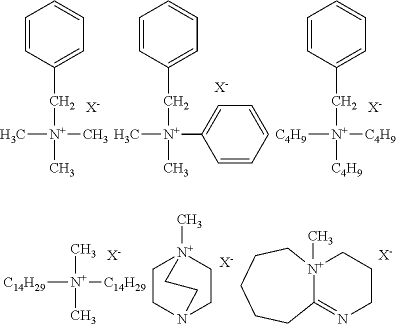

From the viewpoint of charge distribution narrowing and charge distribution retentivity, the total content of the molybdenum nitrogen-containing compound and the nitrogen element-containing compound that does not contain a molybdenum element, which are contained in the silica particles (S), the total content being expressed as a mass ratio N/Si of a nitrogen element to a silicon element, is, for example, preferably 0.005 or more and 0.50 or less, more preferably 0.008 or more and 0.45 or less, even more preferably 0.015 or more and 0.20 or less, and still more preferably 0.018 or more and 0.10 or less.

The mass ratio N/Si in the silica particles (S) is measured using an oxygen/nitrogen analyzer (for example, EMGA-920 manufactured by HORIBA, Ltd.) for a total of 45 seconds, and determined as a mass ratio of N atoms to Si atoms (N/Si). As a pretreatment, the sample is dried in a vacuum at 100° C. for 24 hours or more to remove impurities such as ammonia.

A total extraction amount X of the molybdenum nitrogen-containing compound and the nitrogen element-containing compound that does not contain a molybdenum element, which are extracted from the silica particles (S) by using a mixed solution of ammonia/methanol, is, for example, preferably 0.1% by mass or more with respect to the mass of the silica particles (S). In addition, the total extraction amount X of the molybdenum nitrogen-containing compound and the nitrogen element-containing compound that does not contain a molybdenum element, which are extracted from the silica particles (S) by the mixed solution of ammonia/methanol, and a total extraction amount Y of the molybdenum nitrogen-containing compound and the nitrogen element-containing compound that does not contain a molybdenum element, which are extracted from the silica particles (S) by water (just as X, Y is a mass ratio to the mass of the silica particles (S)) preferably satisfy, for example, Y/X<0.3.

The above relationship shows that the nitrogen element-containing compound contained in the silica particles (S) has the properties of not being easily dissolved in water, that is, the properties of not being easily adsorbed onto the moisture in the air. Therefore, in a case where the above relationship is satisfied, the silica particles (S) are excellent in charge distribution narrowing and charge distribution retentivity.

The extraction amount X is, for example, preferably 0.25% by mass or more and 6.5% by mass or less with respect to the mass of the silica particles (S). Ideally, the ratio Y/X of the extraction amount Y to the extraction amount X is 0.

The extraction amount X and the extraction amount Y are measured by the following method.

First, the silica particles are analyzed with a thermogravimetric analyzer (for example, a gas chromatography mass spectrometer manufactured by Netch Japan Co., Ltd.) at a temperature of 400° C., the mass fractions of compounds in which a hydrocarbon having one or more carbon atoms forms a covalent bond with a nitrogen atom to the silica particles are measured, added up, and adopted as W1.

The silica particles (1 part by mass) are added to 30 parts by mass of an ammonia/methanol solution (manufactured by Sigma-Aldrich Co., LLC., mass ratio of ammonia/methanol=1/5.2) at a liquid temperature of 25° C., the mixture is treated with ultrasonic waves for 30 minutes, and then silica powder and the extract are separated. The separated silica particles are dried in a vacuum dryer at 100° C. for 24 hours. Then, by using a thermogravimetric analyzer, the mass fractions of compounds in which a hydrocarbon having one or more carbon atoms forms a covalent bond with a nitrogen atom to the silica particles are measured at 400° C., added up, and adopted as W2.

The silica particles (1 part by mass) are added to 30 parts by mass of water at a liquid temperature of 25° C. and treated with ultrasonic waves for 30 minutes, and then the silica particles and an extract are separated. The separated silica particles are dried in a vacuum dryer at 100° C. for 24 hours. Then, by using a thermogravimetric analyzer, the mass fractions of compounds in which a hydrocarbon having one or more carbon atoms forms a covalent bond with a nitrogen atom to the silica particles are measured at 400° C., added up, and adopted as W3.

From W1 and W2, extraction amount X=W1−W2 is calculated.

From W1 and W3, extraction amount Y=W1−W3 is calculated.

Hydrophobic Treatment Step

The Manufacturing method according to the present exemplary embodiment may additionally have a hydrophobic treatment step of performing a hydrophobic treatment on the silica particles having the coating structure consisting of the reaction product of the trifunctional silane compound, after or during the attaching step. The hydrophobic treatment step is a step of additionally attaching a hydrophobic structure consisting of a hydrophobic agent to the coating structure consisting of the reaction product of the trifunctional silane compound. The hydrophobic treatment step is performed, for example, in a case where a non-functional group of the trifunctional silane compound used in the coating step is a hydrophilic group or in a case where the degree of hydrophobicity of the silica particles (S) is to be increased.

As the hydrophobic agent, a compound other than the trifunctional silane compound is used. Examples of the hydrophobic agent include a silazane compounds such as hexamethyldisilazane or tetramethyldisilazane, a titanate-based coupling agent, and an aluminum-based coupling agent.

The hydrophobic treatment step is performed, for example, by adding a molybdenum nitrogen-containing compound to the silica particle suspension obtained after the reaction between the silica base particles and the trifunctional silane compound, and further adding a hydrophobic agent to prepare a reaction solution. In a case where the hydrophobic agent is used, for example, it is preferable to heat the reaction solution to a temperature of 40° C. or higher and 70° C. or lower and to stir the reaction solution. The stirring is continued, for example, preferably for 10 minutes or more and 24 hours or less, more preferably for 20 minutes or more and 120 minutes or less, and even more preferably 20 minutes or more and 90 minutes or less.

Drying Step

A drying step of removing water and an alcohol from the reaction solution is performed after the attaching step or the hydrophobic treatment step is performed or while the attaching step or the hydrophobic treatment step is being performed. Examples of the drying method include heat drying, spray drying, and supercritical drying.

In the following description, the reaction solution obtained after performing the attaching step or the hydrophobic treatment step will be called “silica particle suspension”.

Spray drying can be performed by a conventionally known method using a spray dryer (such as a rotary disk spray dryer or a nozzle spray dryer). For example, in a hot air stream, the silica particle suspension is sprayed at a rate of 0.2 L/hour or more and 1 L/hour or less. The temperature of hot air is set such that, for example, the inlet temperature of the spray dryer is preferably in a range of 70° C. or higher and 400° C. or lower and the outlet temperature of the spray dryer is preferably in a range of 40° C. or higher and 120° C. or lower. The inlet temperature is, for example, more preferably in a range of 100° C. or higher and 300° C. or lower. The silica particle concentration in the silica particle suspension is, for example, preferably 10% by mass or more and 30% by mass or less.

Examples of the substance used as the supercritical fluid for supercritical drying include carbon dioxide, water, methanol, ethanol, acetone, and the like. From the viewpoint of treatment efficiency and from the viewpoint of suppressing the occurrence of coarse particles, the supercritical fluid is, for example, preferably supercritical carbon dioxide. Specifically, a step of using supercritical carbon dioxide is performed, for example, by the following operation.

The silica particle suspension is put in an airtight reactor, and then liquefied carbon dioxide is introduced into the reactor. Thereafter, the airtight reactor is heated, and the internal pressure of the airtight reactor is raised using a high-pressure pump such that the carbon dioxide in the airtight reactor is in a supercritical state. Then, the liquefied carbon dioxide is caused to flow into the airtight reactor, and the supercritical carbon dioxide is discharged from the airtight reactor, such that the supercritical carbon dioxide circulates in the silica particle suspension in the airtight reactor. While the supercritical carbon dioxide is circulating in the silica particle suspension, water and the alcohol dissolve in the supercritical carbon dioxide and are removed along with the supercritical carbon dioxide discharged from the airtight reactor. The internal temperature and pressure of the airtight reactor are set such that the carbon dioxide is in a supercritical state. Because the critical point of carbon dioxide is 31.1° C./7.38 MPa, for example, the temperature is set to 40° C. or higher and 200° C. or lower, and the pressure is set to 10 MPa or higher and 30 MPa or lower. The flow rate of the supercritical fluid in the airtight reactor is, for example, preferably 80 mL/sec or more and 240 mL/sec or less.

It is preferable that the silica particles having undergone the drying step, for example, be disintegrated or sieved such that coarse particles and aggregated particles are removed. The silica particles are disintegrated, for example, by a dry pulverizer such as a jet mill, a vibration mill, a ball mill, or a pin mill. The silica particles are sieved, for example, by a vibration sieve, a pneumatic sieving machine, or the like.

Characteristics of Silica Particles (S)

From the viewpoint of charge distribution narrowing and charge distribution retentivity, the silica particles (S) preferably have, for example, the following characteristics.

Average Circularity, Average Primary Particle Size, and Particle Size Distribution Index

The average circularity of the silica particles (S) is, for example, preferably 0.60 or more and 0.96 or less, more preferably 0.65 or more and 0.94 or less, even more preferably 0.70 or more and 0.92 or less, and still more preferably 0.75 or more and 0.90 or less.

The average primary particle size of the silica particles (S) is, for example, preferably 10 nm or more and 200 nm or less, more preferably 20 nm or more and 150 nm or less, even more preferably 30 nm or more and 120 nm or less, and particularly preferably 40 nm or more and 100 nm or less.

The particle size distribution index of the silica particles (S) is, for example, preferably 1.1 or more and 2.0 or less, and more preferably 1.15 or more and 1.6 or less.

The method of measuring the average circularity, average primary particle size, and particle size distribution index of the silica particles (S) is as follows.

The silica particles are imaged using a scanning electron microscope (SEM) (manufactured by Hitachi High-Tech Corporation., 5-4800) at 40,000× magnification. At least 200 silica particles are analyzed by the image processing/analyzing software WinRoof (MITANI CORPORATION). For each of the primary particles, a circular equivalent diameter, an area, and a perimeter are calculated, and circularity=4π×(area of particle image)+(perimeter of particle image)² is calculated. In the circularity distribution, the circularity below which the cumulative percentage of particles having a lower circularity reaches 50% is defined as an average circularity. In the distribution of circular equivalent diameter, the circular equivalent diameter below which the cumulative percentage of particles having smaller circular equivalent diameter reaches 50% is defined as an average primary particle size. In the distribution of circular equivalent diameter, the particle size below which the cumulative percentage of particles having a smaller circular equivalent diameter reaches 16% is defined as D16, the particle size below which the cumulative percentage of particles having a smaller circular equivalent diameter reaches 84% is defined as D84, and particle size distribution index=(D84/D16)^{0.5} is calculated.

Degree of Hydrophobicity

A degree of hydrophobicity of the silica particles (S) is, for example, preferably 10% or more and 60% or less, more preferably 20% or more and 55% or less, and even more preferably 28% or more and 53% or less.

The method of measuring the degree of hydrophobicity of the silica particles is as follows.

Silica particles (0.2% by mass) are added to 50 ml of deionized water. While the mixture is being stirred with a magnetic stirrer, methanol is added dropwise thereto from a burette, and the mass fraction of methanol in the mixed solution of methanol/water at a point in time when the entirety of the sample is precipitated is determined and adopted as a degree of hydrophobicity.

Volume Resistivity

A volume resistivity R of the silica particles (S) is, for example, preferably 1.0×10⁷ Ω·cm or more and 1.0×10^{12.5} Ω·cm or less, more preferably 1.0×10^{7.5} Ω·cm or more and 1.0×10¹² Ω·cm or less, even more preferably 1.0×10⁸ Ω·cm or more and 1.0×10^{11.5} Ω·cm or less, and still more preferably 1.0×10⁹ Ω·cm or more and 1.0×10¹¹ Ω·cm or less. The volume resistivity R of the silica particles (S) can be adjusted by the content of the molybdenum nitrogen-containing compound.

In a case where Ra represents a volume resistivity of the silica particles (S) before baking at 350° C., and Rb represents a volume resistivity of the silica particles (S) after baking at 350° C., a ratio Ra/Rb is, for example, preferably 0.01 or more and 0.8 or less, and more preferably 0.015 or more and 0.6 or less.

The volume resistivity Ra (having the same definition as the aforementioned volume resistivity R) of the silica particles (S) before baking at 350° C. is, for example, preferably 1.0×10⁷ Ω·cm or more and 1.0×10^{12.5} Ω·cm or less, more preferably 1.0×10^{7.5} Ω·cm or more and 1.0×10¹² Ω·cm or less, even more preferably 1.0×10¹ Ω·cm or more and 1.0×10^{11.5} Ω·cm or less, and still more preferably 1.0×10¹¹ Ω·cm or more and 1.0×10¹¹ Ω·cm or less.

The baking at 350° C. is a process of heating the silica particles (A) up to 350° C. at a heating rate of 10° C./min in a nitrogen environment, keeping the silica particles (A) at 350° C. for 3 hours, and cooling the silica particles (A) to room temperature (25° C.) at a cooling rate of 10° C./min.

The volume resistivity of the silica particles (S) is measured as follows in an environment at a temperature of 20° C. and a relative humidity of 50%.

The silica particles (S) are placed on the surface of a circular jig on which a 20 cm² electrode plate is disposed, such that a silica particle layer having a thickness of about 1 mm or more and 3 mm or less is formed. A 20 cm² electrode plate is placed on the silica particle layer such that the silica particle layer is interposed between the electrode plates, and in order to eliminate voids between the silica particles, a pressure of 0.4 MPa is applied on the electrode plate. A thickness L (cm) of the silica particle layer is measured. By using an impedance analyzer (manufactured by Solartron Analytical) connected to both the electrodes placed on and under the silica particle layer, a Nyquist plot in a frequency range of 10-3 Hz or more and 106 Hz or less is obtained. On the assumption that there are three resistance components, bulk resistance, particle interface resistance, and electrode contact resistance, the plot is fitted to an equivalent circuit, and a bulk resistance R(Ω) is determined. From the bulk resistance R(Ω) and the thickness L (cm) of the silica particle layer, a volume resistivity p (Q cm) of the silica particles is calculated by the equation of p=R/L.

Amount of OH Groups

The amount of OH groups in the silica particles (S) is, for example, preferably 0.05 OH groups/nm² or more and 6 OH groups/nm² or less, more preferably 0.1 OH groups/nm² or more and 5.5 OH groups/nm² or less, even more preferably 0.15 OH groups/nm² or more and 5 OH groups/nm² or less, still more preferably 0.2 OH groups/nm² or more and 4 OH groups/nm² or less, and yet more preferably 0.2 OH groups/nm² or more and 3 OH groups/nm² or less.

The amount of OH groups in the silica particles is measured as follows by the Sears method.

Silica particles (1.5 g) are added to a mixed solution of 50 g of water/50 g of ethanol, and the mixture is stirred with an ultrasonic homogenizer for 2 minutes, thereby preparing a dispersion. While the dispersion is being stirred in an environment at 25° C., 1.0 g of a 0.1 mol/L aqueous hydrochloric acid solution is added dropwise thereto, thereby obtaining a test liquid. The test liquid is put in an automatic titration device, potentiometric titration using a 0.01 mol/L aqueous sodium hydroxide solution is performed, and a differential curve of the titration curve is created. In the inflection point where the differential value of the titration curve is 1.8 or more, the titration amount by which the titration amount of the 0.01 mol/L aqueous sodium hydroxide solution is maximized is denoted by E.

From the following equation, a surface silanol group density p (number of surface silanol groups/nm²) in the silica particles is calculated and adopted as the amount of OH groups in the silica particles.

ρ=((0.01×E−0.1)×NA/1,000)/(M×S_{BET}×10¹⁸)Equation:

E: titration amount by which the titration amount of the 0.01 mol/L aqueous sodium hydroxide solution is maximized in the inflection point where the differential value of the titration curve is 1.8 or more, NA: Avogadro's number, M: amount of silica particles (1.5 g), S_{BET}: specific surface area of silica particles (m²/g) measured by the three-point BET nitrogen adsorption method (relative equilibrium pressure is 0.3).

Ratio N_{Mo}/N_{Si} of Net Intensity

In the silica particles (S), from the viewpoint of charge distribution narrowing and charge distribution retentivity, a ratio N_{Mo}/N_{Si} of Net intensity N_{Mo} of the molybdenum element measured by X-ray fluorescence analysis to Net intensity N_{Si} of the silicon element measured by X-ray fluorescence analysis is, for example, preferably 0.035 or more and 0.45 or less. The ratio N_{Mo}/N_{Si} is, for example, more preferably 0.05 or more, even more preferably 0.07 or more, and particularly preferably 0.10 or more. The ratio N_{Mo}/N_{Si} is, for example, more preferably 0.40 or less, even more preferably 0.35 or less, and particularly preferably 0.30 or less.

From the viewpoint of charge distribution narrowing and charge distribution retentivity, the Net intensity N_{Mo} of the molybdenum element of the silica particles (S) is, for example, preferably 5 kcps or more and 75 kcps or less, more preferably 7 kcps or more and 55 kcps or less, even more preferably 8 kcps or more and 50 kcps or less, and still more preferably 10 kcps or more and 40 kcps or less.

The method of measuring the Net intensity N_{Mo} of the molybdenum element and the Net intensity N_{Si} of the silicon element in the silica particles is as follows.

Approximately 0.5 g of silica particles are compressed using a compression molding machine by being pressed under a load of 6 tons for 60 seconds, thereby preparing a disk having a diameter of 50 mm and a thickness of 2 mm. This disk is used as a sample for qualitative quantitative elemental analysis performed under the following conditions by using a scanning X-ray fluorescence spectrometer (XRF-1500, manufactured by Shimadzu Corporation), and Net intensity of each of the molybdenum element and the silicon element is determined (unit: kilo counts per second, kcps).
Tube voltage: 40 kV
Tube current: 90 mA
Measurement area (analysis diameter): diameter of 10 mm
Measurement time: 30 minutes
Anticathode: rhodium

Pore Diameter

For example, in a pore size distribution curve obtained by a nitrogen adsorption method, the silica particles (S) preferably have a first peak in a range of pore diameter of 0.01 nm or more and 2 nm or less and a second peak in a range of pore diameter of 1.5 nm or more and 50 nm or less, more preferably have a second peak in a range of pore diameter of 2 nm or more and 50 nm or less, even more preferably have a second peak in the range of pore diameter of 2 nm or more and 40 nm or less, and particularly preferably have a second peak in a range of pore diameter of 2 nm or more and 30 nm or less.

In a case where the first peak and the second peak are in the above range, the molybdenum nitrogen-containing compound enters deeply into the pores of the coating structure, and the charge distribution is narrowed.

The method of obtaining the pore size distribution curve by the nitrogen adsorption method is as follows.

The silica particles are cooled to the temperature of liquid nitrogen (−196° C.), nitrogen gas is introduced, and the amount of nitrogen gas adsorbed is determined by a constant volume method or a gravimetric method. The pressure of nitrogen gas introduced is slowly increased, and the amount of nitrogen gas adsorbed is plotted for each equilibrium pressure, thereby creating an adsorption isotherm. From the adsorption isotherm, a pore size distribution curve in which the ordinate shows a frequency and the abscissa shows a pore diameter is obtained by the equation of the BJH method. Then, from the obtained pore size distribution curve, an integrated pore volume distribution in which the ordinate shows a volume and the abscissa shows a pore diameter is obtained, and the position of peak of the pore diameter is checked.

Aspect (A) and Aspect (B)

From the viewpoint of charge distribution narrowing and charge distribution retentivity, the silica particles (S) preferably satisfy, for example, any of the following aspects (A) and (B).
Aspect (A): an aspect in which in a case where A represents a pore volume of pores having a diameter of 1 nm or more and 50 nm or less determined from a pore size distribution curve obtained by a nitrogen adsorption method before baking at 350° C., and B represents a pore volume of pores having a diameter of 1 nm or more and 50 nm or less determined from a pore size distribution curve obtained by a nitrogen adsorption method after baking at 350° C., B/A is 1.2 or more and 5 or less, and B is 0.2 cm³/g or more and 3 cm³/g or less.

Hereinafter, “pore volume A of pores having a diameter of 1 nm or more and 50 nm or less determined from a pore size distribution curve obtained by a nitrogen adsorption method before baking at 350° C.” will be called “pore volume A before baking at 350° C.”, and “pore volume B of pores having a diameter of 1 nm or more and 50 nm or less determined from a pore size distribution curve obtained by a nitrogen adsorption method after baking at 350° C.” will be called “pore volume B after baking at 350° C.”.

The baking at 350° C. is a process of heating the silica particles (A) up to 350° C. at a heating rate of 10° C./min in a nitrogen environment, keeping the silica particles (A) at 350° C. for 3 hours, and cooling the silica particles (A) to room temperature (25° C.) at a cooling rate of 10° C./min.

The method of measuring the pore volume is as follows.

The silica particles are cooled to the temperature of liquid nitrogen (−196° C.), nitrogen gas is introduced, and the amount of nitrogen gas adsorbed is determined by a constant volume method or a gravimetric method. The pressure of nitrogen gas introduced is slowly increased, and the amount of nitrogen gas adsorbed is plotted for each equilibrium pressure, thereby creating an adsorption isotherm. From the adsorption isotherm, a pore size distribution curve in which the ordinate shows a frequency and the abscissa shows a pore diameter is obtained by the equation of the BJH method. From the obtained pore size distribution curve, an integrated pore volume distribution in which the ordinate shows a volume and the abscissa shows a pore diameter is obtained. From the obtained integrated pore volume distribution, an integral value of pore volumes of pores having a diameter in a range of 1 nm or more and 50 nm or less is calculated and adopted as “pore volume of pores having a diameter of 1 nm or more and 50 nm or less”.

The ratio B/A of the pore volume B after baking at 350° C. to the pore volume A before baking at 350° C. is, for example, preferably 1.2 or more and 5 or less, more preferably 1.4 or more and 3 or less, and even more preferably 1.4 or more and 2.5 or less.

The pore volume B after baking at 350° C. is, for example, preferably 0.2 cm³/g or more and 3 cm³/g or less, more preferably 0.3 cm³/g or more and 1.8 cm³/g or less, and even more preferably 0.6 cm³/g or more and 1.5 cm³/g or less.

The aspect (A) is an aspect in which a sufficient amount of the nitrogen element-containing compound is adsorbed onto at least some of the pores of the silica particles.
Aspect (B): an aspect in which in a case where C represents an integral value of signals observed in a range of chemical shift of −50 ppm or more and −75 ppm or less in a ²⁹Si solid-state nuclear magnetic resonance (NMR) spectrum obtained by a cross-polarization/magic angle spinning (CP/MAS) method (hereinafter, also called “Si—CP/MAS NMR spectrum”), and D represents an integral value of signals observed in a range of chemical shift of −90 ppm or more and −120 ppm or less in the same spectrum, a ratio C/D is 0.10 or more and 0.75 or less.

The Si—CP/MAS NMR spectrum can be obtained by measuring a sample by nuclear magnetic resonance spectroscopy under the following conditions.
Spectrometer: AVANCE 300 (manufactured by Bruker)
Resonance frequency: 59.6 MHz
Measurement nucleus: ²⁹Si
Measurement method: CPMAS method (using Bruker's standard ParC sequence cp.av)
Waiting time: 4 sec
Contact time: 8 ms
Number of times of integration: 2,048
Measurement temperature: room temperature (25° C., measured temperature)
Center frequency of observation: −3975.72 Hz
MAS rotation speed: 7.0 mm-6 kHz
Reference substance: hexamethylcyclotrisiloxane

The ratio C/D is, for example, preferably 0.10 or more and 0.75 or less, more preferably 0.12 or more and 0.45 or less, and even more preferably 0.15 or more and 0.40 or less.

In a case where the integral value of all signals in Si—CP/MAS NMR spectrum is regarded as 100%, the ratio of the integral value C (Signal ratio) of the signals observed in a range of chemical shift of −50 ppm or more and −75 ppm or less is, for example, preferably 5% or more, and more preferably 7% or more. The upper limit of the ratio of the integral value C of the signals is, for example, 60% or less.

Aspect (B) is an aspect having a low-density coating structure in which a sufficient amount of a nitrogen element-containing compound can be adsorbed onto at least a part of the surface of silica particles. The low-density coating structure is, for example, a coating structure consisting of a reaction product of a trifunctional silane compound, which is a SiO_{2/3}CH₃ layer, for example.

The silica particles (S) can be used, for example, as an additive component or a major component of developers, powder paint, cosmetics, rubber, abrasives, and the like.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

Unless otherwise specified, synthesis, treatment, manufacturing, and the like are carried out at room temperature (25° C.±3C).

### Example 1

Granulating Step

Methanol and aqueous ammonia in the amounts and concentrations shown in Table 1 are put into a glass container equipped with a metal stirring rod, a dripping nozzle, and a thermometer, and stirred and mixed together, thereby preparing an alkali catalyst solution. The temperature of the alkali catalyst solution is adjusted to 25° C., and the alkali catalyst solution is subjected to nitrogen purging. Then, while the alkali catalyst solution is being stirred at a liquid temperature kept at 25° C., tetramethoxysilane (TMOS) and aqueous ammonia in the amounts and concentrations shown in Table 1 are simultaneously added dropwise to the solution, thereby obtaining a silica base particle suspension.

Coating Step

The liquid temperature of the silica base particle suspension is adjusted to 60° C., and methyltrimethoxysilane (MTMS) in the amount shown in Table 1 is added for 120 minutes to the suspension being stirred at a temperature kept at 60° C. such that MTMS reacts, thereby forming a coating structure consisting of a reaction product of MTMS on the surface of the silica base particles.

Attaching Step

The liquid temperature of the silica particle suspension after the reaction of between the silica base particles and MTMS is adjusted to the temperature shown in Table 1. In a state where the liquid temperature of the silica particle suspension is maintained, aqueous ammonia, an aqueous diethylamine solution, or an aqueous diethylamine solution is added as necessary to the suspension being stirred, and TP-415 (Hodogaya Chemical Co., Ltd., CAS registry number 117342-25-3) is further added thereto, thereby obtaining a reaction solution of the attaching step. The composition of the reaction solution is shown in Table 2. In a state where the liquid temperature of the reaction is maintained, the reaction solution is stirred for 60 minutes.

Drying Step

The reaction solution is moved to a drying container. While the reaction solution is being stirred, liquefied carbon dioxide is injected into the drying container, the internal temperature and internal pressure of the drying container are raised to 150° C. and 15 MPa respectively, and the reaction solution is continuously stirred in a state where the temperature and pressure are kept and the supercritical state of the carbon dioxide is maintained. The carbon dioxide is flowed in and out at a flow rate of 5 L/min, and water and an alcohol are removed for 120 minutes, thereby obtaining silica particles.

Measurement of Characteristics of Silica Particles

By the measurement method described above, the average primary particle size, the particle size distribution index, the average circularity, N_{Mo}/N_{Si}, B/A, and the abundance ratio of molybdenum lumps relating to the silica particles are measured. The results are shown in Table 2.

Measurement of Charge Distribution

The silica particles (2 parts by mass) and 100 parts by mass of crosslinked acrylic resin particles (manufactured by NIPPON SHOKUBAI CO., LTD., MA1010) are mixed together, and 5 parts by mass of the mixture is mixed with 50 parts by mass of ferrite particles (manufactured by JFE Chemical Corporation, KNI-106GSM), thereby preparing a sample for measuring charge.

The sample is stirred for 5 minutes with a paint shaker (manufactured by TURBULA, TURBULA shaker/mixer) in a chamber at a temperature of 20° C. and a relative humidity of 50%, and evaluated by image analysis of charge spectrography (CSG).

Whether the charge distribution is wide or narrow is determined based on a value obtained by dividing the difference between a charge amount Q(20) accounting for an integrated cumulative percentage of 20% in the charge distribution and a charge amount Q(80) accounting for an integrated cumulative percentage of 80% in the charge distribution by a charge amount Q(50) accounting for an integrated cumulative percentage of 50% in the charge distribution, that is, a value of [Q(80)−Q(20)]/Q(50). The smaller the value, the narrower the charge distribution. The values are classified as follows. The results are shown in Table 2.
A: The value of [Q(80)−Q(20)]/Q(50) is 0.75 or less.
B: The value of [Q(80)−Q(20)]/Q(50) is more than 0.75 and 0.85 or less.
C: The value of [Q(80)−Q(20)]/Q(50) is more than 0.85 and 1.0 or less.
D: The value of [Q(80)−Q(20)]/Q(50) is more than 1.0.

Measurement of Change Rate of Charge Amount

The silica particles (2 parts by mass) and 100 parts by mass of crosslinked acrylic resin particles (manufactured by NIPPON SHOKUBAI CO., LTD., MA1010) are mixed together, and 5 parts by mass of the mixture is mixed with 50 parts by mass of ferrite particles (manufactured by JFE Chemical Corporation, KNI-106GSM), thereby preparing a sample for measuring charge amount.

The sample is left to stand under high temperature and high humidity (a temperature of 30° C. and a relative humidity of 90%) for 7 days. Before and after standing, the charge amount of the sample is measured using a blow-off charge amount measuring device (Toshiba Chemical Corporation., TB-200). The absolute value of a change rate of charge amount|(charge amount before standing−charge amount after standing)/charge amount before standing| is calculated and classified as follows. The results are shown in Table 2.
A: 0 or more and less than 0.2
B: 0.2 or more and less than 0.35
C: 0.35 or more and less than 0.5
D: 0.5 or more

### Examples 2 to 33 and Comparative Examples 1 to 3

Silica particles are manufactured in the same manner as in Example 1, except that the conditions of each step are changed as described in Table 1. The characteristics and charge distribution of the silica particles are measured in the same manner as in Example 1. The results are shown in Table 2.

TABLE 1

| | Granulating step | | | | | | | Coating | Attaching step | | |
|---|---|---|---|---|---|---|---|---|---|---|---|
| | Preparation of alkali catalyst solution | | | | Dropwise addition | | | step | | Addition | TP- |
| | Alcohol | | Aqueous ammonia | | TMOS | Aqueous ammonia | | MTMS | | for | 415 |
| | | Parts | | Parts | Parts | | Parts | Parts | Liquid | composition | Parts |
| | | by | Concentration | by | by | Concentration | by | by | temperature | adjustment | by |
| | Type | mass | % by mass | mass | mass | % by mass | mass | mass | ° C. | Type | mass |
| Comparative | Methanol | 445 | 10.0 | 49 | 257 | 8.0 | 67 | 10 | 60 | Ammonia | 3.7 |
| Example 1 | | | | | | | | | | | |
| Example 1 | Methanol | 469 | 10.0 | 49 | 258 | 8.0 | 67 | 10 | 25 | Ammonia | 2.5 |
| Example 2 | Methanol | 469 | 10.0 | 49 | 258 | 8.0 | 67 | 10 | 25 | Ammonia | 3.8 |
| Example 3 | Methanol | 445 | 10.0 | 49 | 257 | 8.0 | 67 | 10 | 62 | Ammonia | 2.5 |
| Example 4 | Methanol | 445 | 10.0 | 49 | 257 | 8.0 | 67 | 10 | 60 | Ammonia | 3.7 |
| Example 5 | Methanol | 469 | 10.0 | 49 | 258 | 8.0 | 67 | 10 | 60 | Ammonia | 3.7 |
| Example 6 | Methanol | 445 | 10.0 | 49 | 257 | 8.0 | 67 | 10 | 62 | Ammonia | 5.0 |
| Example 7 | Methanol | 445 | 10.0 | 49 | 257 | 8.0 | 67 | 10 | 62 | Ammonia | 5.0 |
| Example 8 | Methanol | 445 | 10.0 | 49 | 257 | 8.0 | 67 | 10 | 60 | Ammonia | 3.7 |
| Example 9 | Methanol | 445 | 10.0 | 49 | 257 | 8.0 | 67 | 10 | 61 | Ammonia | 2.5 |
| Example 10 | Methanol | 445 | 10.0 | 49 | 257 | 8.0 | 67 | 10 | 60 | Ammonia | 4.0 |
| Example 11 | Methanol | 445 | 10.0 | 49 | 257 | 8.0 | 67 | 10 | 60 | Ammonia | 3.7 |
| Example 12 | Methanol | 445 | 10.0 | 49 | 257 | 8.0 | 67 | 10 | 60 | Ammonia | 3.8 |
| Comparative | Methanol | 445 | 10.0 | 49 | 257 | 8.0 | 67 | 10 | 62 | Ammonia | 3.7 |
| Example 2 | | | | | | | | | | | |
| Example 13 | Methanol | 950 | 9.1 | 110 | 450 | 8.0 | 30 | 100 | 52 | Ammonia | 3.7 |
| Example 14 | Methanol | 994 | 9.8 | 104 | 547 | 8.0 | 117 | 22 | 48 | Ammonia | 3.8 |
| Example 15 | Methanol | 994 | 9.8 | 104 | 547 | 8.0 | 117 | 3 | 38 | Ammonia | 3.7 |
| Example 16 | Methanol | 950 | 12.0 | 250 | 1100 | 8.0 | 222 | 50 | 60 | Ammonia | 4.0 |
| Example 17 | Methanol | 950 | 12.0 | 250 | 1100 | 8.0 | 330 | 50 | 60 | Ammonia | 3.3 |
| Example 18 | Methanol | 950 | 12.0 | 250 | 1100 | 8.0 | 330 | 50 | 60 | Ammonia | 3.7 |
| Example 19 | Methanol | 950 | 12.0 | 250 | 1100 | 8.0 | 410 | 50 | 40 | Ammonia | 3.7 |
| Example 20 | Methanol | 469 | 10.0 | 49 | 258 | 8.0 | 67 | 10 | 60 | Ammonia | 2.5 |
| Example 21 | Methanol | 950 | 9.6 | 166 | 1000 | 8.0 | 134 | 50 | 61 | Ammonia | 2.5 |
| Example 22 | Methanol | 469 | 10.0 | 49 | 258 | 8.0 | 67 | 10 | 60 | Ammonia | 1.2 |
| Example 23 | Methanol | 950 | 9.6 | 166 | 1000 | 8.0 | 134 | 50 | 61 | Ammonia | 7.0 |
| Example 24 | Methanol | 950 | 9.6 | 166 | 1000 | 8.0 | 134 | 50 | 60 | Ammonia | 10.0 |
| Example 25 | Methanol | 445 | 10.0 | 49 | 257 | 8.0 | 67 | 10 | 42 | Ammonia | 3.7 |
| Example 26 | Methanol | 445 | 10.0 | 49 | 257 | 8.0 | 67 | 10 | 42 | Ammonia | 4.0 |
| Example 27 | Methanol | 994 | 9.8 | 104 | 547 | 8.0 | 117 | 22 | 52 | Ammonia | 10.0 |
| Example 28 | Methanol | 445 | 10.0 | 49 | 257 | 8.0 | 67 | 10 | 42 | Ammonia | 5.0 |
| Comparative | Methanol | 469 | 10.0 | 49 | 258 | 8.0 | 67 | 10 | 60 | Ammonia | 3.7 |
| Example 3 | | | | | | | | | | | |
| Example 29 | Methanol | 445 | 10.0 | 49 | 257 | 8.0 | 67 | 10 | 60 | Dimethylamine | 2.5 |
| Example 30 | Ethanol | 445 | 10.0 | 49 | 257 | 8.0 | 67 | 10 | 61 | Diethylamine | 3.8 |
| Example 31 | 1-Propanol | 445 | 10.0 | 49 | 257 | 8.0 | 67 | 10 | 60 | Ammonia | 2.5 |
| Example 32 | 2-Propanol | 445 | 10.0 | 49 | 257 | 8.0 | 67 | 10 | 61 | Ammonia | 3.8 |
| Example 33 | 2-Methyl-2- | 445 | 10.0 | 49 | 257 | 8.0 | 67 | 10 | 62 | Ammonia | 3.8 |
| | propanol | | | | | | | | | | |

TABLE 2

| | Composition of reaction solution | | | | | | | | | | | | | |
|---|---|---|---|---|---|---|---|---|---|---|---|---|---|---|
| | | | Solid | | | | | | | | | | | |
| | | | content | | | | | | | | | | | |
| | | | (silica | | | Silica particles | | | | | | | | |
| | | | particles | | | | Particle | | | | | | | |
| | | | having | | Am- | Average | size | | | | | Abundance | | Change |
| | | | coating | TP- | monia + | primary | distribu- | Average | | | | ratio of | Charge | rate of |
| | Water | Alcohol | structure) | 415 | amine | size | tion | circular- | N_{MO}/ | | | molybdenum | distribu- | charge |
| | % by | % by | % by | % by | % by | particle | index | ity | Nₛᵢ | B/A | B | lumps | tion | amount |
| | mass | mass | mass | mass | mass | nm | — | — | — | — | cm³/g | % | — | — |
| Comparative | 9.17 | 59.1 | 30.0 | 1.11 | 0.1 | 56.1 | 1.18 | 0.903 | 0.29 | 3.50 | 1.10 | 11.2 | D | D |
| Example 1 | | | | | | | | | | | | | | |
| Example 1 | 3.1 | 93.0 | 3.8 | 0.1 | 0.2 | 62.5 | 1.10 | 0.870 | 0.21 | 4.00 | 1.20 | 4.5 | B | B |
| Example 2 | 1.7 | 91.5 | 6.5 | 0.3 | 0.5 | 66.7 | 1.10 | 0.900 | 0.33 | 3.80 | 0.95 | 0.8 | A | A |
| Example 3 | 5.8 | 63.1 | 29.4 | 0.7 | 1.2 | 56.1 | 1.18 | 0.903 | 0.22 | 3.80 | 0.94 | 0.6 | A | A |
| Example 4 | 7.99 | 59.1 | 30.0 | 1.11 | 1.8 | 56.1 | 1.18 | 0.903 | 0.32 | 3.80 | 1.00 | 1.6 | A | A |
| Example 5 | 6.0 | 49.7 | 41.0 | 1.5 | 2.4 | 64.3 | 1.10 | 0.881 | 0.32 | 3.40 | 1.04 | 1.2 | A | A |
| Example 6 | 12.6 | 55.4 | 28.2 | 1.41 | 2.4 | 56.1 | 1.18 | 0.903 | 0.44 | 4.10 | 1.10 | 0.6 | A | A |
| Example 7 | 9.6 | 56.2 | 30.0 | 1.5 | 2.7 | 56.1 | 1.18 | 0.903 | 0.43 | 4.10 | 1.00 | 0.9 | A | A |
| Example 8 | 7.99 | 56.1 | 30.0 | 1.11 | 2.8 | 56.1 | 1.18 | 0.903 | 0.31 | 3.90 | 1.00 | 1.2 | A | A |
| Example 9 | 10.5 | 56.4 | 29.4 | 0.7 | 3.2 | 56.1 | 1.18 | 0.903 | 0.22 | 3.60 | 0.94 | 0.5 | A | A |
| Example 10 | 12.4 | 56.6 | 26.4 | 1.1 | 3.9 | 56.1 | 1.18 | 0.903 | 0.35 | 3.80 | 0.94 | 0.8 | B | A |
| Example 11 | 7.79 | 57.1 | 30.0 | 1.11 | 4.0 | 56.1 | 1.18 | 0.903 | 0.33 | 3.80 | 1.10 | 1.1 | B | A |
| Example 12 | 3.0 | 51.1 | 40.0 | 1.5 | 4.5 | 56.0 | 1.20 | 0.900 | 0.35 | 4.80 | 0.80 | 3.9 | B | B |
| Comparative | 6.79 | 57.1 | 30.0 | 1.11 | 5.0 | 56.1 | 1.18 | 0.903 | 0.49 | 4.30 | 1.10 | 6.2 | C | D |
| Example 2 | | | | | | | | | | | | | | |
| Example 13 | 7.99 | 56.1 | 30.0 | 1.11 | 2.8 | 10.0 | 1.20 | 0.770 | 0.16 | 2.61 | 2.56 | 2.3 | A | B |
| Example 14 | 5.8 | 52.4 | 38.5 | 1.5 | 3.0 | 47.7 | 1.13 | 0.916 | 0.16 | 1.50 | 0.85 | 1.5 | B | A |
| Example 15 | 7.99 | 56.1 | 30.0 | 1.11 | 2.8 | 70.0 | 1.08 | 0.884 | 0.15 | 2.00 | 1.20 | 0.1 | A | A |
| Example 16 | 5.6 | 49.0 | 41.0 | 1.6 | 2.8 | 80.0 | 1.08 | 0.910 | 0.08 | 2.20 | 1.21 | 0.5 | A | A |
| Example 17 | 6.5 | 50.0 | 40.0 | 1.3 | 2.2 | 120 | 1.08 | 0.940 | 0.06 | 2.20 | 1.28 | 0.5 | A | A |
| Example 18 | 7.99 | 56.1 | 30.0 | 1.11 | 2.8 | 120 | 1.08 | 0.940 | 0.08 | 2.16 | 1.25 | 2.4 | A | B |
| Example 19 | 7.99 | 56.1 | 30.0 | 1.11 | 2.8 | 200 | 1.10 | 0.930 | 0.08 | 2.21 | 1.30 | 2.8 | A | B |
| Example 20 | 3.1 | 93.0 | 3.8 | 0.1 | 0.2 | 64.3 | 1.20 | 0.088 | 0.029 | 1.65 | 0.87 | 4.6 | B | B |
| Example 21 | 7.2 | 64.4 | 26.4 | 0.7 | 1.3 | 61.0 | 1.22 | 0.880 | 0.056 | 1.60 | 0.87 | 1.3 | A | A |
| Example 22 | 9.2 | 64.4 | 26.4 | 0.31 | 0.4 | 64.3 | 1.10 | 0.881 | 0.10 | 1.67 | 0.87 | 1.1 | B | A |
| Example 23 | 8.5 | 59.1 | 26.4 | 1.8 | 3.2 | 61.0 | 1.22 | 0.880 | 0.16 | 1.67 | 0.85 | 1.7 | A | A |
| Example 24 | 12.7 | 54.0 | 26.4 | 2.6 | 4.3 | 61.0 | 1.20 | 0.880 | 0.22 | 1.67 | 0.90 | 1.5 | B | A |
| Example 25 | 6.0 | 49.7 | 41.0 | 1.5 | 2.4 | 56.1 | 1.18 | 0.903 | 0.32 | 3.80 | 0.94 | 1.4 | A | A |
| Example 26 | 12.4 | 56.6 | 26.4 | 1.1 | 3.9 | 56.1 | 1.18 | 0.903 | 0.35 | 3.70 | 0.94 | 0.9 | A | A |
| Example 27 | 8.3 | 60.0 | 25.0 | 2.5 | 4.2 | 48.0 | 1.10 | 0.920 | 0.41 | 1.50 | 0.85 | 1.5 | B | A |
| Example 28 | 9.6 | 56.2 | 30.0 | 1.5 | 2.7 | 56.1 | 1.18 | 0.903 | 0.44 | 3.80 | 0.94 | 1.4 | A | A |
| Comparative | 6.79 | 57.1 | 30.0 | 1.11 | 5.0 | 64.3 | 1.10 | 0.881 | 0.63 | 3.80 | 0.90 | 5.2 | C | C |
| Example 3 | | | | | | | | | | | | | | |
| Example 29 | 11.2 | 60.5 | 26.4 | 0.7 | 1.2 | 60.0 | 1.10 | 0.840 | 0.22 | 3.70 | 0.93 | 1.2 | A | A |
| Example 30 | 9.8 | 61.0 | 26.4 | 1.0 | 1.8 | 60.0 | 1.20 | 0.910 | 0.33 | 4.00 | 0.95 | 1.5 | A | A |
| Example 31 | 12.0 | 59.8 | 26.4 | 0.7 | 1.1 | 60.0 | 1.10 | 0.840 | 0.22 | 3.90 | 1.00 | 2.3 | A | B |
| Example 32 | 8.8 | 62.1 | 26.4 | 1.0 | 1.7 | 60.0 | 1.20 | 0.910 | 0.33 | 3.80 | 0.98 | 1.5 | A | A |
| Example 33 | 7.8 | 63.2 | 26.4 | 1.0 | 1.6 | 63.0 | 1.10 | 0.900 | 0.35 | 3.80 | 0.93 | 0.9 | A | A |

A manufacturing method of silica particles comprising:
coating of forming a coating structure consisting of a reaction product of atrifunctional silane compound on a surface of silica base particles;
attaching a nitrogen element-containing compound containing a molybdenum element to the coating structure in a reaction solution which contains water, an alcohol, silica particles having the coating structure consisting of the reaction product of the trifunctional silane compound, the nitrogen element-containing compound containing the molybdenum element, and at least one compound selected from the group consisting of ammonia and an amine and in which a total amount of ammonia and an amine is 0.2% by mass or more and 4.5% by mass or less; and
drying of removing the water and the alcohol from the reaction solution.

(((2)))

The manufacturing method of silica particles according to (((1))),
wherein the reaction solution contains at least one compound selected from the group consisting of ammonia, dimethylamine, and diethylamine, and
a total amount of ammonia, dimethylamine, and diethylamine contained in the reaction solution is 0.2% by mass or more and 4.5% by mass or less.

(((3)))

The manufacturing method of silica particles according to (((1))) or (((2))),
wherein the nitrogen element-containing compound containing a molybdenum element is at least one compound selected from the group consisting of a quaternary ammonium salt containing a molybdenum element and a mixture of a quaternary ammonium salt and a metal oxide containing a molybdenum element.

(((4)))

The manufacturing method of silica particles according to (((1))) or (((2))),
wherein the nitrogen element-containing compound containing a molybdenum element is a compound with a CAS registry number 117342-25-3.

(((5)))

The manufacturing method of silica particles according to any one of (((1))) to (((4))),
wherein the trifunctional silane compound is a trifunctional silane compound represented by Formula (S),

RSiX₃ Formula (S)
R represents a hydrocarbon group having 1 or more and 6 or less carbon atoms, and three X's each independently represent a hydroxyl group or a hydrolyzable group.

(((6)))

The manufacturing method of silica particles according to (((5))),
wherein the three X's in Formula (S) each independently represent a methoxy group or an ethoxy group.

(((7)))

The manufacturing method of silica particles according to any one of (((1))) to (((6))),
wherein in the reaction solution, a content of the nitrogen element-containing compound containing a molybdenum element is 1 part by mass or more and 5 parts by mass or less with respect to 100 parts by mass of the silica particles having the coating structure consisting of the reaction product of the trifunctional silane compound.

(((8)))

The manufacturing method of silica particles according to any one of (((1))) to (((7))),
wherein the alcohol contained in the reaction solution is at least one alcohol selected from the group consisting of methanol, ethanol, 1-propanol, 2-propanol, and 2-methyl-2-propanol.

(((9)))

The manufacturing method of silica particles according to any one of (((1))) to (((8))),
wherein an amount of the alcohol contained in the reaction solution is 45% by mass or more and 95% by mass or less.

(((10)))

The manufacturing method of silica particles according to any one of (((1))) to (((9))),
wherein the attaching includes stirring the reaction solution for 1 hour or more while keeping a temperature of the reaction solution in a range of 25° C. or higher and 65° C. or lower.

(((11)))

The manufacturing method of silica particles according to any one of (((1))) to (((10))), further comprising:
granulating the silica base particles by a sol-gel method before the coating.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A manufacturing method of silica particles, comprising:
coating of forming a coating structure consisting of a reaction product of a trifunctional silane compound on a surface of silica base particles;
attaching a nitrogen element-containing compound containing a molybdenum element to the coating structure in a reaction solution which contains water, an alcohol, silica particles having the coating structure consisting of the reaction product of the trifunctional silane compound, the nitrogen element-containing compound containing the molybdenum element, and at least one compound selected from the group consisting of ammonia and an amine and in which a total amount of ammonia and an amine is 0.2% by mass or more and 4.5% by mass or less; and
drying of removing the water and the alcohol from the reaction solution.

2. The manufacturing method of silica particles according to claim 1,
wherein the reaction solution contains at least one compound selected from the group consisting of ammonia, dimethylamine, and diethylamine, and
a total amount of ammonia, dimethylamine, and diethylamine contained in the reaction solution is 0.2% by mass or more and 4.5% by mass or less.

3. The manufacturing method of silica particles according to claim 1,
wherein the nitrogen element-containing compound containing a molybdenum element is at least one compound selected from the group consisting of a quaternary ammonium salt containing a molybdenum element and a mixture of a quaternary ammonium salt and a metal oxide containing a molybdenum element.

4. The manufacturing method of silica particles according to claim 1,
wherein the nitrogen element-containing compound containing a molybdenum element is a compound with a CAS registry number 117342-25-3.

5. The manufacturing method of silica particles according to claim 1,
wherein the trifunctional silane compound is a trifunctional silane compound represented by Formula (S),
RSiX₃ Formula (S)
R represents a hydrocarbon group having 1 or more and 6 or less carbon atoms, and three X's each independently represent a hydroxyl group or a hydrolyzable group.

6. The manufacturing method of silica particles according to claim 5,
wherein the three X's in Formula (S) each independently represent a methoxy group or an ethoxy group.

7. The manufacturing method of silica particles according to claim 1,
wherein in the reaction solution, a content of the nitrogen element-containing compound containing a molybdenum element is 1 part by mass or more and 5 parts by mass or less with respect to 100 parts by mass of the silica particles having the coating structure consisting of the reaction product of the trifunctional silane compound.

8. The manufacturing method of silica particles according claim 1,
wherein the alcohol contained in the reaction solution is at least one alcohol selected from the group consisting of methanol, ethanol, 1-propanol, 2-propanol, and 2-methyl-2-propanol.

9. The manufacturing method of silica particles according to claim 1,
wherein an amount of the alcohol contained in the reaction solution is 45% by mass or more and 95% by mass or less.

10. The manufacturing method of silica particles according to claim 1,
wherein the attaching includes stirring the reaction solution for 1 hour or more while keeping a temperature of the reaction solution in a range of 25° C. or higher and 65° C. or lower.

11. The manufacturing method of silica particles according to claim 1, further comprising:
granulating the silica base particles by a sol-gel method before the coating.
